(19) United States
(12) Patent Application Publication
(10) Pub. No.: US 2007/0252720 A1
(43) Pub. Date: Nov. 1, 2007

(54) MULTIFUNCTION PORTABLE SECURITY SYSTEM

(75) Inventors: Rickey D. Hughes, Providence, UT (US); James T. Reese, Logan, UT (US); Maria C. Nielsen, Hyrum, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: U.S. SAFETY AND SECURITY, L.L.C., Logan, UT (US)

(21) Appl. No.: 11/740,399

(22) Filed: Apr. 26, 2007

Related U.S. Application Data
(60) Provisional application No. 60/795,375, filed on Apr. 27, 2006.

(51) Int. Cl. G08B 3/00; G08B 13/00

(52) U.S. Cl. 340/691.3; 340/541

(57) ABSTRACT

A security system and method for warning a potential intruder. One example system includes detector configured to detect the presence of a potential intruder within close proximity to the security system. At least one warning device is also configured to communicate warning signals to the potential intruder. The example system further includes a control circuit configured to cause the warning devices to automatically communicate a series of warning signals in a progressive manner to the potential intruder. Each subsequent warning signal becomes more severe than the last warning signal, and each subsequent warning signal is typically only provided if the potential intruder is detected by the detector within a predetermined time window since the communication of a previous warning signal.

### CROSS-REFERENCE TO RELATED APPLICATIONS

This application claims the benefit of U.S. Provisional Application No. 60/795,375, filed Apr. 27, 2006, which is incorporated herein by reference in its entirety.

### BACKGROUND

1. The Field of the Invention

The present invention relates generally to security systems. More specifically, the present invention relates to methods and portable systems for providing security in a locality.

2. The Relevant Technology

Vandalism and theft are on the rise, particularly in areas such as construction sites, parking lots, residential and commercial buildings, and the like. These sites, which may include new homes or large commercial buildings which are under construction, are vulnerable due to the lack of security and an available means of providing proper protection. A need exists of providing portable and cost-effective protection to contractors who have significant investments in materials, tools and equipment. Furthermore, many sites pose safety hazards to children and others who may inadvertently be placing themselves in danger and exposing the property owner to liability. Therefore, a need also exists of a system that is capable of providing cost-effective safety warnings to people who may be exposing themselves to a potential safety hazard.

The subject matter claimed herein is not limited to embodiments that solve any disadvantages or that operate only in environments such as those described above. Rather, this background is only provided to illustrate one exemplary area where some embodiments described herein may be practiced.

### BRIEF SUMMARY

One example embodiment is directed to a security system. The security system may include, for example, a detector configured to detect the presence of a potential intruder within close proximity to the security system. At least one warning device is also configured to communicate warning signals to the potential intruder. The example system further includes a control circuit configured to cause the warning devices to automatically communicate a series of warning signals in a progressive manner to the potential intruder. Each subsequent warning signal becomes more severe than the last warning signal, and each subsequent warning signal is typically only provided if the potential intruder is detected by the detector within a predetermined time window since the communication of a previous warning signal.

Variations on this general approach are also illustrated. For example, in another embodiment, the security system may include a variety of other features. For example, a chassis may be provided for containing the detector, the warning devices, and the control circuit. The chassis may be supported by a portable support member, wherein the security system is configured to be easily portable between different locations.

A variety of warning devices may be employed. For example, in one embodiment, the security system includes at least one light that may be used to light a surrounding area and/or for a warning mechanism. Also, at least one speaker may be configured to sound at an alarm and/or a recorded voice message for providing an audible warning. In one embodiment, the security system includes a communication device configured to transmit a message to an offsite location, such as a police station, to provide a notification of the potential intruder.

One example embodiment is directed to a method of warning a potential intruder. The method may be practiced, for example, in a security system that may be portable in nature. The example method may include detecting the presence of a potential intruder within close proximity to a security system and communicating a first automated warning signal to the potential intruder. If the potential intruder remains within the vicinity, the method also includes detecting the continued presence of the potential intruder within close proximity to the security system within a predetermined window of time since the communicating of the first automated warning signal. If the potential intruder is detected a second time, the method further includes communicating a second automated warning signal to the potential intruder. The second automated warning signal contains a more severe warning than the first automated warning signal.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates one example of a multifunction portable security system.

FIG. 1B illustrates an example security chassis for a multifunction portable security system.

FIG. 1C illustrates one example of a remote control user interface that may be employed for controlling a multifunction portable security system.

FIG. 2 is a schematic illustration of one example power and control circuit for a multifunction portable security system.

FIG. 3 illustrates one example of a flow diagram for providing warning signals to a potential intruder.

FIG. 4 illustrates one example of a flow diagram for providing various security functions.

FIG. 5 illustrates one example of an interrupt service flow diagram.

### DETAILED DESCRIPTION

In the following detailed description of various embodiments of the invention, reference is made to the accompanying drawings which form a part hereof, and in which are shown by way of illustration specific embodiments whereby the invention may be practiced. It is to be understood that other embodiments may be utilized and structural changes may be made without departing from the scope of the present invention

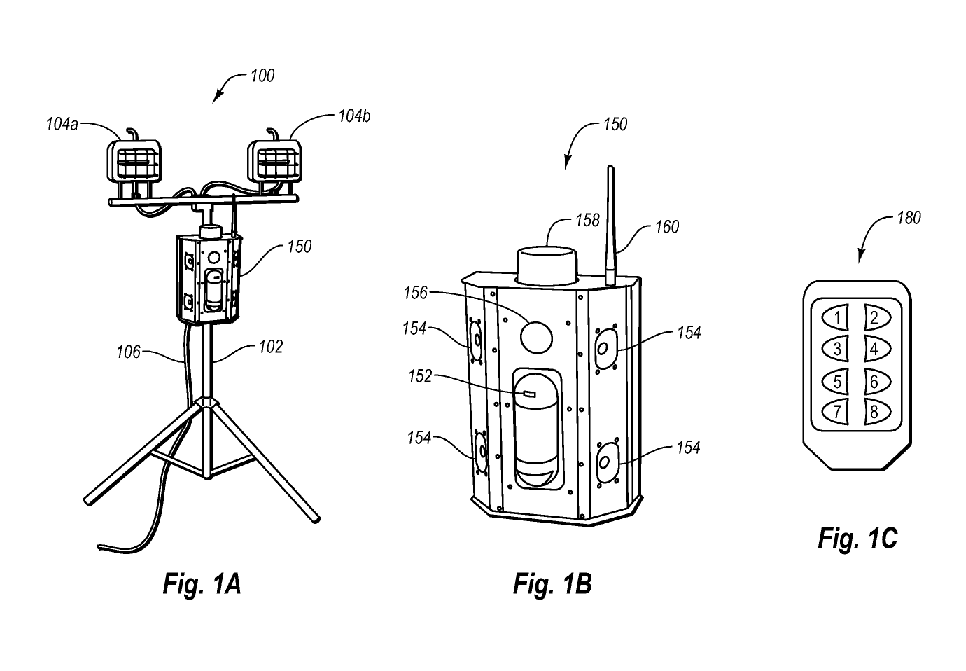

FIG. 1A illustrates one exemplary embodiment of a Multifunction Portable Security System (MPSS) 100. The example MPSS 100 includes a support member 102, such as a heavy duty telescoping tripod utility lighting stand, or any other portable support structure. Although the illustrated MPSS 100 is portable in nature, it will be appreciated that many of the features disclosed herein may be implemented in a security system that is not portable in nature. The support member 102 supports one or more lights 104a and 104b. The lights may include, for example, two 500 Watt quartz lamps, or other similar lights commonly used for lighting outdoor areas, which may be configured to swivel or tilt independently. The illustrated MPSS 100 may further include a security chassis 150 which may include a variety of devices for providing security within a locality.

Referring now to FIG. 1B, a more detailed depiction of the security chassis 150 is provided. The security chassis 150 may include a motion detector 152, an amplifier (not shown), a programmable voice chip (not shown), speaker system 154, a siren 156 (which, in one embodiment, may be integrated with the speaker system 154), a strobe flasher 158, a microcontroller unit (MCU) (not shown), among other components. The system functionality and operation may be controlled by a user interface device, such as a display device, an RF remote control, and the like. The MPSS 100 may be powered by a battery and/or may plug directly into an AC power source via an AC power cord 106. The MPSS 100 also provides a communication device (not shown) for contacting the police or other security unit in case of intrusion. The communication device may include a wired or wireless communication link for communicating via telephone lines, cellular networks, computer networks, Local Area Networks (LAN), Wide Area Networks (WAN), and the like. An antenna 160 may also be provided, such as, for example, a 100 MHz flexible antenna, and the like. For example, the communication device may initially contact a predetermined party, and the contacted party can then contact the police or other enforcement agency. In one embodiment, normally closed contacts may also be provided to enable triggering of the external dial in case wires or the power supply are cut or disconnected by the intruder.

In one embodiment, the security chassis 150 further includes a microphone (not shown). The microphone may receive sound from the surrounding area, which may be transmitted via the communication device during a suspected intrusion so that the contacted party can listen to the sounds near the site of the MPSS 100 to determine if further action is needed.

In one embodiment, the MPSS 100 may further include a NEMA (“National Electrical Manufacturers Association”) receptacle for the tripod lights 104a and 104b and screw terminals for an optional external telephone dialer or other communications device. The strobe flasher 158 may include, for example, a flasher designed to operate from a 12 VDC power source. In one embodiment, the flasher's DC line may be fed by an open-collector driver. The MCU may control the operation of the flasher.

The high-intensity siren 156 may include, for example, a 125 dB siren, such as a three terminal device intended for operation from a 12 VDC power source. The open collector driver may feed the siren control wire and may be activated by the MCU.

In one embodiment, the motion detector 152 may include a passive infrared motion detector that is designed for outdoor use with UV filtering and dual optical beams to reduce false triggering. The motion detector 152 may include an OPTEX VX-402 (Standard Model), which is powered by a 12 VDC power source, and provides normally closed or normally open relay contacts. The motion detector's 152 relay contacts may connect to the MCU input. The status of these contacts is polled at ¼ second intervals when any security or utility mode is activated, as described in detail below. Since the operation of the user interface may generate MCU interrupts, any timing or warning sequence is easily aborted using the remote. Although the illustrated MPSS 100 utilizes a motion sensor 152, any detector may be used for detecting the presence of a potential intruder, such as a heat sensor, a sound detector, other types of optical sensors, and the like.

The speaker system 154 may include four speakers mounted on the security chassis 150, as illustrated in FIG. 1B. In one embodiment, the speaker terminals are connected in parallel giving a net impedance of 4 Ohms. The speakers 154 connect to a power amplifier on the system board which is in turn fed by a programmable voice chip, described below. For example, a 20 Watt power amplifier may be employed to drive the speakers 154. Other power amplifiers may also be used for a variety of situations, as will be appreciated by one of skill in the art.

As mentioned previously, in one embodiment, a hand-held controller, such as the remote controller 180 illustrated in FIG. 1C, may be provided as a user interface for controlling the functionality of the MPSS 100. The remote control 180 and corresponding receiver IC may include integrated components. In one embodiment, the remote control 180 may operate similar to a garage door opener, for example, and may incorporate a plurality of unique ID's. Both the remote control 180 and the MPSS 100 may share identical IDs so that the remote control 180 can successfully communicate with the MPSS 100. The unique ID enables use of multiple systems 100 in a single location or multiple remotes 180 configured for the same system 100. In one example, the ID for the MPSS 100 and the remote control 180 are set via a ten position DIP switch, creating a possibility of 1024 possible unique IDs, where an MPSS and remote control pair use the same DIP switch settings.

In one embodiment, the MPSS 100 electronics may be housed on two separate circuit boards. For example, a Power Supply Board may contain individual power supplies and the high voltage and other relay control circuits. A Systems Board may contain the MCU, logic, remote control receiver, audio power amplifier and programmable voice chip.

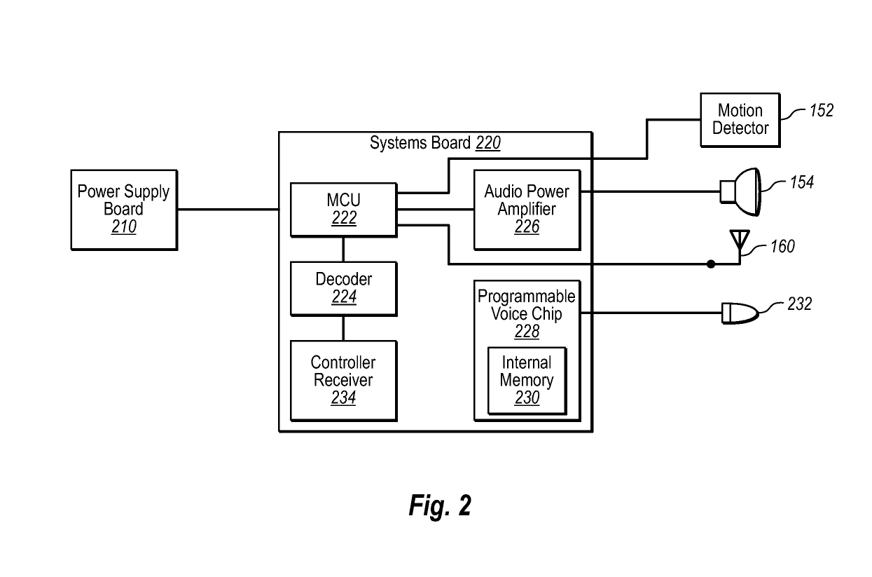

FIG. 2 illustrates one embodiment of the electronics 200. The Power Supply Board 210 may be located near the bottom of the MPSS chassis 150 to reduce wire lengths and facilitate external connections. In one embodiment, the Power Supply Board 210 provides +12 VDC, −12 VDC, +18 VDC, unregulated and −18 VDC unregulated. The unregulated voltages may feed the audio power amplifier. These higher voltages may provide extra power without posing a noise problem by using high ripple rejection. In one embodiment, the MCU, logic and programmable voice chips may be powered by a 5 VDC supply. Individual, on-card regulators may be included to provide these voltages. Analog, digital and RF supplies may be handled independently. Two relays may also be mounted on the Power Supply Board 210. A heavy duty relay may control the AC feed to the tripod lights 104. A second relay may provide normally open or closed contacts for use by an external telephone driver or other communications device. Normally open contacts may be employed so that cutting or pulling the power cord 106 will automatically activate the dialer.

The Systems Board 220 may connect to the Power Supply Board 210, the passive infrared motion detector 152, the speakers 154 and the antenna 160. The example Systems Board 220 may decode the serial data from the remote control using a decoder 224 and may send the appropriate signal to the MCU 222 for processing. The Systems Board 220 receives the input signal from the motion detector 152 and sends it the MCU 222 for processing. Audio signals stored in the programmable voice chip 228, described below, are fed to the audio power amplifier 226 and speakers 154 on command from the MCU 222. The MCU 222 manages all system functions and feeds various drive commands to the voice chip 228 and the other warning devices via the Power Supply Board 210.

Voice warnings may be audibly projected to a potential intruder via the speakers 154. As described previously, the voice messages may be stored in the Voice Chip 228. The voice chip 228 may include sufficient memory to store 60 or more seconds of total message space usable with a number of record and playback modes. In one embodiment, voice messages may be recorded in the voice chip 228 using an external programmer. In another embodiment, the voice chip 228 may be set to operate only in a playback mode after it is initially programmed.

In one embodiment, an “End of Message” (EOM) signal may also be stored in the voice chip's internal memory 230 which flags the end of each stored message. This EOM signal may be used by the MCU 222 to determine when a message ends and to aid in shuffling through individual messages to rapidly cue up the required message for playback. In one embodiment, the EOM signal of the voice chip may connect to an LED 232 and to the MCU 222. The LED 232 may be set to off during playback and may illuminate when the EOM signal is present and the given message ends. The MCU 222 may poll the EOM signal of the voice chip 228, waiting for the message to finish prior to executing the next event. The MCU 222 also may poll the EOM signal of the voice chip 228 while stepping through messages to cue the required message. When cuing, pulses may be generated following each EOM pulse. For example, to cue the Nth message, N−1 cycles of start and EOM pulses may be generated. In one embodiment, pressing any button on the user interface, such as the remote control 180 can cause the MCU 222 to generate an interrupt and thus abort the voice message currently running.

The example systems board 220 may include a controller receiver IC 234 to demodulate a signal received from the user interface. For example, the controller receiver 234 may demodulate an RF signal received from the remote control 180. The controller receiver 234 may also send a serial digital signal to the serial decoder 224. The serial decoder 224 may output the user interface functions, as described below. The serial decoder 224 may be programmed to only decode the signals from the user interface if the unique ID of the user interface matches the unique ID of the MPSS 100, or in one example, if the ten-position DIP switch of the MPSS 100 matches the corresponding DIP switch settings in the remote control 180. In one embodiment, the output from the serial decoder 224 may feed a binary priority encoder to re-encode the remote for reducing the number of inputs required by the MCU 222. The MCU 222 may then interpret the input received from the user interface and may execute the associated function. The MCU 222 may be configured to generate an interrupt anytime an input is received from the user interface. The user interface thereby may be given priority and can abort any timing sequence or function.

In one embodiment, the MCU 222 polls the status of the motion detector 152 at one-quarter second intervals only when the security mode or the utility mode, as will be described below, is selected. The motion detector 152 and associated circuitry may generate a positive going pulse when an intruder enters the detection field. The motion detector's 152 normally closed contacts may be connected to the MCU 222 and an external pull-up resistor to give the required pulse height and polarity. The motion detector's 152 relay contacts may be triggered by the detector's internal processing of the dual infrared sensors. Any valid motion may cause the detector's contacts to energize for a minimum duration of two seconds, thus triggering the MCU 222 on any given poll cycle. The MCU 222 may start a given event timing sequence at the leading edge of the pulse generated by the motion detector 152 if a predefined security or utility mode is selected. If no security mode is selected, the MCU 222 may be programmed to ignore the motion detector 152.

An analog output of the voice chip 228 may be connected directly to a speaker 154. However, because the voice chip 228 may not have sufficient internal power to drive the array of speakers 154 or provide sufficient volume for the MPSS 100 application, an amplifier 226 may also be provided for generating sufficient power to drive the speaker array 154 in the security chassis 150. For example, in one embodiment, outputs of the voice chip 228 are differential at Vcc and at ground potential in standby—when no message is running. In one embodiment, dual operation amplifier chips (not shown) may be used to provide a differential input and buffering to eliminate the DC component shifts as the voice chip 228 analog output stage switches on and begins or ends a message. The dual operational amplifier chips may further add low pass filtering to reduce transients generated in the voice chip 228. In one embodiment, the audio amplifier 226 may provide roughly 20 Watts of power to sufficiently drive the speaker array 154 in the security chassis 150. The audio circuitry may further include a potentiometer (not shown) to adjust sound volumes below clipping or to a desired level.

As described previously, in one embodiment, a remote control may be used for controlling the modes of the MPSS 100. For example, and referring to FIG. 1C, the remote control 180 may include an eight button interface, having buttons designated 1 through 8 beginning with the upper left button then from left to right top to bottom. The remote control may include an FCC Part 15 compliant wireless RF remote control operating in ISM (Industrial, Scientific and Medical) Band. The buttons on the remote control 180 may be configured to activate various modes within the MPSS 100. Many of the example modes will now be described. Although the example remote control 180 may be used for selecting the modes of the MPSS 100, many other user interfaces may also be used, such as a touchscreen display, a multi-selectable switch, and the like.

A first setting on the user interface may be selected to disable all security functions. In one embodiment, when the first setting is selected, a voice message may be sounded, such as “System disabled.” Any current mode is aborted when the disabled mode is selected.

A second setting on the user interface may be selected to engage a Utility Mode. In one embodiment, when the first setting is selected, a voice message may be sounded, such as “Utility mode activated.” This mode may turn on the tripod lights 104 when motion is detected and may also sound the message “Welcome” at the first detected motion. The lights 104 remain on for a fixed length of time before shutting off. The sequence repeats when any further motion is detected.

A third setting on the user interface may be selected to engage the Full Security Mode. The Full Security Mode may provide a series of progressive warnings in a predefined sequence upon detecting the presence of a potential intruder. The predefined sequence provides a series of warnings to a potential intruder that has been detected by the motion sensor 152. In one example embodiment, the first time the motion sensor detects the presence of an intruder, the MPSS 100 provides the intruder with a simple warning according to a first warning procedure. If the motion sensor 152 detects the continued presence of the intruder after the first warning has been issued, a more severe warning is issued according to a second warning procedure. This process continues until ultimately reaching the most severe warning procedure. Each warning procedure corresponds with a “security risk level”, or “escalation level”, which increases with each instance that the motion sensor 102 detects the presence of an intruder within a predefined amount of time. For example, after detecting the potential intruder a first time, the system may wait for 30 seconds before searching for the potential intruder a second time to provide the potential intruder an opportunity to leave the vicinity. When the system begins searching for the potential intruder a second time, if the potential intruder is not detected within ten minutes, for example, the process may be reinitialized by setting the security risk level to its lowest level.

For example, when operating in the Full Security Mode, the first time that a motion detected may activate the tripod lights 104 and may sound a warning message, such as: “Warning, intruder detected, you have entered a protected area and must leave immediately”, in accordance with a first security risk level. The first warning message may also include a message that warns the detected intruder of a potential safety hazard within the vicinity and instructing the detected individual to depart immediately. If no further motion is detected at the end of the message, the tripod lights 104 are turned off and no further warning is given. However, if further motion is detected, a second warning procedure is initiated in accordance with a second security risk level. For example, the tripod lights 104 are again turned on, the strobe 158 begins to flash and the warning message, such as “Security breach, dispatching in five, four, three, two, one . . . ”, along with the sound of a telephone dialer and other simulated police traffic sounds may be generated. At the end of the message, the siren may be activated for a fixed duration if no further motion is detected. Contacts connecting an optional external telephone dialer or other communications device may be opened as the second message begins. Should motion be detected a third and subsequent time after the siren has shut off, the MPSS 100 may initiate a third warning procedure in accordance with a third security risk level. For example, the tripod lights 104 may again be turned on, strobe flasher 158 and siren and again opens the contacts connecting to the optional external telephone dialer or other communications device. The MPSS 100 may continue to operate in this manner—directly activating the tripod lights, strobe flasher and siren when detecting motion—until the system is reset using a user interface.

A fourth setting on the user interface may be selected to manually activate the tripod lights 104, strobe flasher 158 and/or siren 156 independent of the motion detector 152. This mode may be used in a panic situation to scare off any would-be intruders.

A fifth setting on the user interface may be selected to activate the Silent Alarm Mode. In one embodiment, when the fifth setting is selected, a voice message may be sounded, such as “silent alarm activated.” In this mode, the motion detector 152 causes the contacts of the optional telephone dialer or other communications device to open thus contacting a security unit to provide notification of an intrusion. No visual or audible warnings are activated in this mode.

A sixth setting on the user interface may be selected to manually activate the tripod lights 104. In one embodiment, when the sixth setting is selected, a voice message may be sounded, such as “lights activated” when pressed. This button can be used to illuminate the construction site or other areas requiring protection when entering after dark.

A seventh setting on the user interface may be selected to trigger the external contacts thus activating the external dialer or other communications device, without sounding a voice message. The user interface may reserve additional selections for future applications.

Although the above listing of selections and corresponding functionalities is provided as one example of the various modes of the MPSS 100, various other configurations may be employed for providing a variety of security functions.

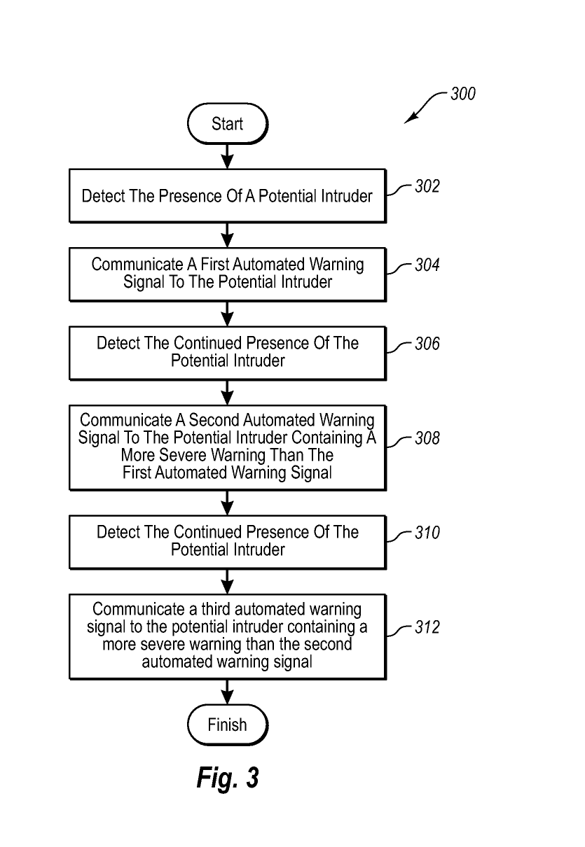

FIG. 3 illustrates one embodiment of an aspect of a method 300 that can be used for warning a potential intruder. The method 300 may be practiced, for example, in a security system that may be portable in nature, such as the MPSS 100 described in FIGS. 1A and 1B.

The method 300, beginning at 302, detects the presence of a potential intruder within close proximity to the security system. The presence of the potential intruder may be detected by any detector, such as the motion sensor 152, illustrated in FIG. 1A. Upon detecting the potential intruder, the method 300 communicates, at 304 a first automated warning signal to the potential intruder.

The method 300, at 306, detects the continued presence of the potential intruder within close proximity to the security system. If the potential intruder is detected within a predetermined amount of time since the communicating of the first automated warning signal (at 304), then the method 300 also communicates a second automated warning signal to the potential intruder, denoted at 308. The second automated warning signal contains a more severe warning than the first automated warning signal

The method 300 continues to monitor for the detected potential intruder, and, if the potential intruder remains within close proximity to the security system, the method further includes, at 310, detecting the continued presence of the potential intruder. If the potential intruder is detected the third time within a predetermined amount of time since the communicating of the second automated warning signal (at 308), then the method 300 also communicates a third automated warning signal to the potential intruder, as denoted at 312. The third automated warning signal contains a more severe warning than the second automated warning signal.

As described previously, the automated warning signals may include a variety of warning types. For example, the automated warning signals may include an audible warning signal, such as a recorded voice message and/or an audible alarm signal. Furthermore, the automated warning signals may include the activation of at least one light, such as a strobe light, for a predetermined amount of time.

Furthermore, during one or more of the automated warning signals, a message may be transmitted to an offsite location to provide a notification of the potential intruder. For example, a notification may be transmitted to the police station or other security unit.

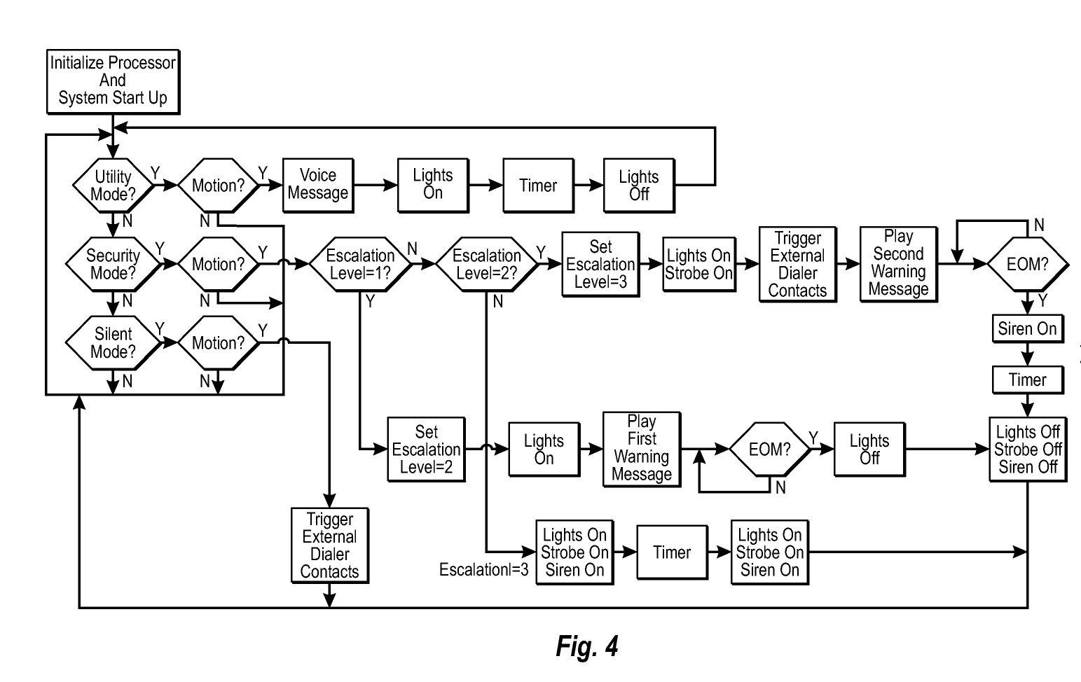

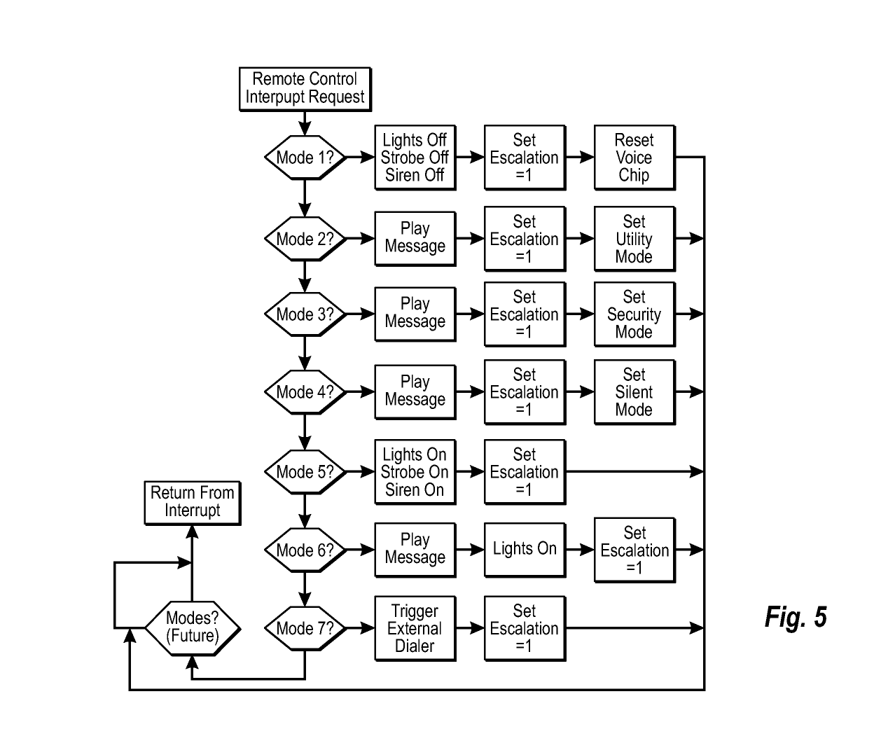

FIGS. 4 and 5 illustrate additional example program flow diagrams. In particular, FIG. 4 provides one example of a flow diagram for the Utility, Security, and Silent modes, described previously. FIG. 5 provides one example of a flow diagram describing actions to be taken by the system 100 immediately after being set to a new mode. In one embodiment, the main program enters an infinite loop after initialization testing only for the various security modes. Selecting any of the modes on the user interface (e.g., remote control 180) causes the MCU 222 to generate an interrupt (see FIG. 5). As described above, in one embodiment, the user interface can be used set the assigned mode and exit the interrupt. Changing the mode causes the program to branch through the flow diagram for that particular mode as illustrated in FIG. 4, and will, perform the corresponding action.

As illustrated in FIG. 4, when the full security mode is selected, an escalation bit (or security risk level bit) is set to keep track of the number of times the motion detector has initiated a timing sequence. Escalation of 1 indicates the system is in the lowest security state and has not previously been triggered by an intruder. Escalation of 2 indicates one prior event and the MCU 222 will initiate the complete timing sequence. Escalation of 3 indicates the entire warning sequence has played out and, in the present embodiment, subsequent motion will cause the MCU 222 to turn on the tripod lights 104, strobe 158 and siren 156 for a fixed length of time and then turn them off. Similarly, higher security risk levels may be employed for providing further warning signals to a potential intruder. Selecting any of the other settings on the user interface may reset the escalation level to 1.

As described above, most buttons on the remote control may generate a voice acknowledgment. All messages including the voice acknowledgement and warnings can be stored sequentially in the voice chip 228. An “End of Message” cue may follow each message. When a particular message is called for, the MCU 222 may switch the voice chip 228 to the MSG CUE Mode and advance through the messages until the pointer is positioned at the beginning of the required message.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A security system, comprising:
a detector configured to detect the presence of a potential intruder within close proximity to the security system;
at least one warning device configured to communicate warning signals to the potential intruder; and
a control circuit configured to cause the at least one warning device to automatically communicate a series of the warning signals in a progressive manner to the potential intruder in accordance with a predefined schedule, wherein each subsequent warning signal becomes more severe and wherein each subsequent warning signal is provided if the potential intruder is detected by the detector within a predetermined time window since the communication of a previous warning signal.

2. The security system as recited in claim 1, further comprising a portable support member configured to mount a chassis containing the detector, the warning device and the control circuit, wherein the security system is configured to be easily portable between different locations.

3. The security system as recited in claim 1, wherein the warning device includes a speaker configured to sound at least one of an alarm and a recorded voice message for providing an audible warning wherein the speaker is activated by the control circuit for at least one of the progressive warning signals.

4. The security system as recited in claim 1, further comprising at least one light configured to be used for at least one of lighting a surrounding area and one of the warning devices wherein the least one of the lights is activated by the control circuit for at least one of the progressive warning signals.

5. The security system as recited in claim 1, further comprising a communication device configured to transmit a message to an offsite location to provide a notification of the potential intruder, wherein the communication device is activated following at least one of the progressive warning signals.

6. The security system as recited in claim 5, wherein the communication device is further configured to automatically transmit the message to the offsite location if a power source for the security system is disabled.

7. The security system as recited in claim 1, further comprising a user interface configured to receive a selection of one or more modes of operation to be performed by the control circuit, wherein the modes of operation include at least a disabled mode for disabling the warning signals and a security mode for providing the warning signals in the progressive manner.

8. The security system as recited in claim 7, wherein the modes of operation further include a manual activation mode for manually activating at least one of the warning devices.

9. The security system as recited in claim 7, wherein the modes of operation further include a silent notification mode for contacting a security unit without activating the at least one warning device.

10. The security system as recited in claim 7, wherein the modes of operation further include a utility mode for turning on least one of the lights for a predetermined amount of time after the detector detects the presence of a human.

11. The security system as recited in claim 7, wherein the user interface is a remote control device.

12. The security system as recited in claim 1, wherein the series of the warning signals comprises at least a first warning signal including a recorded voice message providing an audible warning to vacate an area, a second warning signal including a recorded voice message providing an audible warning that a security unit will be contacted, and a third warning signal including an audible alarm signal.

13. The security system as recited in claim 12, wherein at least one of the first, second and third warning signals is accompanied by the activation of at least one warning light.

14. A method for warning a potential intruder, the method comprising:
detecting the presence of a potential intruder within close proximity to a security system;
communicating a first automated warning signal to the potential intruder;
detecting the continued presence of the potential intruder within close proximity to the security system within a predetermined amount of time since the communicating of the first automated warning signal; and
communicating a second automated warning signal to the potential intruder, the second automated warning signal containing a more severe warning than the first automated warning signal.

15. The method as recited in claim 14, wherein at least one of the first and second automated warning signals includes an audible warning signal including at least one of a recorded voice message and an audible alarm signal.

16. The method as recited in claim 14, wherein at least one of the first and second automated warning signals includes activating at least one light for a predetermined amount of time.

17. The method as recited in claim 14, wherein at least one of the first and second automated warning signals includes transmitting a message to an offsite location to provide a notification of the potential intruder.

18. The method as recited in claim 14, wherein the first automated warning signal includes a recorded voice message providing an audible warning to vacate an area and the second automated warning signal includes a recorded voice message providing an audible warning that a security unit will be contacted.

19. The security system as recited in claim 18, wherein at least one of the first and second automated warning signals is accompanied by the activation of at least one warning light.

20. The method as recited in claim 14, further comprising:
detecting the continued presence of the potential intruder within close proximity to the security system within a predetermined amount of time since the communicating of the second automated warning signal; and
communicating a third automated warning signal to the potential intruder, the third automated warning signal containing a more severe warning than the second automated warning signal.

21. The method as recited in claim 20, wherein the third automated warning signal includes activating an audible alarm signal and activating a strobe light.

22. A security system comprising:
a detector configured to detect the presence of a potential intruder within close proximity to the security system;
at least one light configured to be used for at least one of lighting a surrounding area and a warning mechanism;
at least one speaker configured to sound at least one of an alarm and a recorded voice message for providing an audible warning;
a communication device configured to transmit a message to an offsite location to provide a notification of the potential intruder;
a control circuit configured to control the at least one light, the at least one speaker and the communication device in order to communicate a series of the warning signals in a progressive manner to the potential intruder in accordance with a predefined schedule, wherein each subsequent warning signal becomes more severe and wherein each subsequent warning signal is provided if the potential intruder is detected by the detector within a predetermined time window since the communication of a previous warning signal;
a chassis containing at least the detector, the at least one speaker, the communication device and the control circuit; and
a portable support member for mounting the chassis, wherein the security system is configured to be easily portable between different locations.

23. The security system as recited in claim 22, further comprising a user interface configured to receive a selection of one or more modes of operation to be performed by the control circuit, wherein the modes of operation include at least a disabled mode for disabling the warning signals and a security mode for providing the warning signals in the progressive manner.

24. The security system as recited in claim 23, wherein the modes of operation further include a manual activation mode for manually activating at least one of the warning devices.

25. The security system as recited in claim 23, wherein the modes of operation further include a silent notification mode for contacting a security unit without activating the at least one warning device.

26. The security system as recited in claim 23, wherein the modes of operation further include a utility mode for turning on at least one of the lights for a predetermined amount of time after the detector detects the presence of a human.

27. The security system as recited in claim 23, wherein the user interface is a remote control device.

28. The security system as recited in claim 22, wherein the series of the warning signals comprises at least a first warning signal including a recorded voice message providing an audible warning to vacate an area, a second warning signal including a recorded voice message providing an audible warning that a security unit will be contacted, and a third warning signal including an audible alarm signal.

29. The security system as recited in claim 28, wherein at least one of the first, second and third warning signals is accompanied by the activation of at least one of the lights.
